(19) United States
(12) Patent Application Publication
(10) Pub. No.: US 2026/0012838 A1
(43) Pub. Date: Jan. 8, 2026

(54) SURVIVAL TIME BASED DATA TRANSMISSION IN WIRELESS COMMUNICATION SYSTEM

(71) Applicant: Telefonaktiebolaget LM Ericsson (publ), Stockholm (SE)

(72) Inventors: Yanpeng Yang, Järfälla (SE); Ying Sun, Täby (SE)

(21) Appl. No.: 18/993,396

(22) PCT Filed: Jul. 12, 2022
(86) PCT No.: PCT/SE2022/050708

§ 371 Date: Jan. 10, 2025

(51) Int. Cl. H04W 28/02; H04L 1/00; H04L 1/1812

(52) U.S. Cl. CPC H04W 28/0236; H04L 1/0003; H04L 1/0009; H04L 1/1812

(57) ABSTRACT

Embodiments of the present disclosure provide a method performed by a network node for transmission of data packets to a wireless device. The method comprises obtaining a packet delay budget, PDB, wherein the PDB represents a maximum allowable delay for a data packet. The method comprises determining a total delay time interval indicating a delay incurred for an estimated number of consecutive data packets transmitted from the network node to the wireless device. The method comprises transmitting the data packets to the wireless device based on if the determined total delay time interval exceeds the obtained PDB or not. Corresponding network node, and computer program products are also disclosed.

### TECHNICAL FIELD

The present disclosure relates to wireless communication systems. More particularly, it relates to methods, network node, and computer program products for transmission of data in a wireless communication system.

### BACKGROUND

Wireless connectivity is a key requirement to support evolution of industries and their mission critical industrial activities as well as less critical communication needs. The wireless connectivity supports emerging technology tools and their applications such as, digital twins, smart workspaces, smart robots, virtual assistants, or the like.

Main drivers for the wireless connectivity are:
Replacing (or avoiding) cables, which are costly to deploy and maintain/troubleshoot;
Connecting machines or parts of equipment that are impossible or impractical to connect by wire (for example, fast-moving parts);
Preventive maintenance and big-data analytics, by connecting large numbers of sensors; and
Furthering industry expectation to implement 5G technologies within operational technologies as economy of scale.

The wireless connectivity requirements for manufacturing use cases are very diverse. A majority of identified industry automation use cases are today connected through fixed industrial networks. Typical use cases in the industry automation are motion control, robot control, production line and process control. The current wireless connected use cases are typically of less critical nature as monitoring and parametrization. In automotive factories, the traffic consists mainly of real-time traffic, which is carried by protocols with highly-integrated protocol stacks such as, for example, Profmet Real-Time stack. A transmission control protocol/Internet Protocol, TCP/IP, protocol stack is mainly used for carrying messages pertaining to start-up configuration, notifications and non-critical alarm messages; with preventive monitoring. Hence the wireless connectivity requirements are very use case and application specific.

Latency is expected to be the dominating deciding factor on whether a use case can be deployed using a long term evolution, LTE, or whether a new radio, NR, is required. Latency with a guaranteed upper bound is also very essential for critical automation use cases, since packets need to arrive on time, otherwise they are considered lost.

Mobile Broadband, MBB, is a use case that mobile operators earn money on and consequently the use case they optimize their networks for and the use case which their vendors optimize their products for.

MBB traffic is dominated by video and web traffic. The MBB traffic requires excellent network performance, which is a very important factor for customer satisfaction. However, there are no strict quality of service, Qos, requirements associated with the MBB traffic. Applications (and consumers) supporting the MBB traffic are adaptive and can typically tolerate variations in network performance.

Most of the MBB traffic is carried via transport protocols, such as, a TCP, with reliable message transfer. This means that a packet loss typically is visible to the applications only as a degradation of network throughput. The applications adapt dynamically to such throughput variations. Thus, the MBB traffic have no strict requirements on the packet loss, but rather have soft requirements to provide good end-user experience. Similarly, there are no strict network latency requirements associated with the MBB traffic. Though there is a relationship between latency and TCP throughput, jitter is usually tolerated. However, the packet loss has a bigger negative impact on TCP throughput than jitter. As such, 3GPP systems use network-internal retransmissions such as, for example, Hybrid Automatic Repeat Request, HARQ, retransmissions to deliver packets without any upper bound on latency.

As opposed to the applications supported by the MBB (i.e., MBB applications), many industrial applications are related to non-adaptive control systems with strict network performance requirements. Some of the industrial applications consider a communication system/wireless communication system to be unavailable if the communication system does not fulfill the Qos required by the applications. The QoS herein usually means ability to successfully deliver a packet within a specified upper-bound delay budget (i.e., a packet delay budget, PDB). The QoS requirements are usually expressed as a target reliability calculated as a percentage value of an amount of transmitted packets successfully delivered within the PDB required by the targeted application, divided by a total number of transmitted packets.

Further, the applications may support survival time. The survival time indicates how tolerant the application is to unsuccessful packet deliver, which is partly governed by how many consecutive lost application packets that application can accept before performing one or more emergency actions, such as, for example, emergency shut-down and production stop. Thus, the survival time refers to time period during which the application can manage some packet loss without performing the emergency actions. The survival time depends on implementation of the application and differs a lot between different industries and use cases, from 10 s of seconds down to 10 milliseconds, ms, 1 ms or even 0 ms. 3GPP TR 22.804 discloses some examples.

For the applications supporting the survival time, a reliability requirement indicates a survival time window during which a desired level of QoS has to be fulfilled that is at least one data packet has to be delivered successfully within the survival time window.

For an application with a survival time equal to 0 ms, the reliability requirement, for example, 1-1e-6, indicates the survival time window comprising the PDB during which the desired level of QoS has to be fulfilled. Retransmissions with the communication system such as, HARQ retransmissions can be acceptable, as long as the complete packet can be delivered with the PDB. If the communication system is unable to deliver the packet in time, the application considers that the packet is lost and immediately considers that the communication system is unavailable without any survival time.

For an application with a survival time greater than 0 ms, the reliability requirement indicates the survival time window comprising a sum of the PDB and the survival time of the application during which the desired level of Qos has to be fulfilled. Thus, for the application with the survival time greater than Oms, there are not one but two reliability requirements to consider:
1. The probability for each individual packet being unsuccessful (denoted Pi)
2. The probability of more than X consecutive packets being unsuccessful (denoted Px), where X largely depends on the survival time.

If probability of more than X consecutive packets being unsuccessful is, for example, 1e-6, the probability for each individual packet being unsuccessful can be higher than that.

The application with the survival time greater than 0 ms may, for example, accept that one packet is not delivered successfully within the PDB, but if two consecutive packets are not delivered successfully, the application performs the one or more emergency actions.

FIG. 1 illustrates examples of how two different applications experience a same sequence of events, where the application implemented in a user device sends application packets A-G, but where the communication system is not able to deliver packets B, C, E, F, and G to the user device successfully in due time. In the illustrated example, one application has the survival time equal to 0 ms and another application has the survival time greater than 0 ms. The application with the survival time equal to 0 ms considers the communication system unavailable as soon as the packet B is not delivered successfully. The application with the survival time greater than 0 ms can in this example tolerate two consecutive unsuccessful packets. However, if three consecutive packets are unsuccessful, the application considers the communication system unavailable. Thus, the application with the survival time greater than 0 ms still considers that the communication system is available when the packet B as well as when the packet C are not delivered successfully and then delivery of the packet D is successful. Thereby, the application does not consider the communication system/service to be down even if the packets B and C were lost.

But when three consecutive packets such as packets E, F and G, are unsuccessfully delivered to the user device, the application considers the communication system/service to be unavailable. On considering that the communication system is unavailable, the application performs the one or more emergency actions. For example in an industrial environment, upon considering that the communication system is unavailable, the application initiates emergency shutdown of a production cell or a production line, for example, to avoid damage to machinery, products or humans.

Further, a radio access network, RAN, of the communication system includes a scheduler feature, for example, RAN scheduler feature (also referred to be a scheduler) for distributing/scheduling radio interface and radio base station, RBS, resources between user and control data flows requesting transmission in a cell. Thus, providing a priority for a robust system control signaling and retransmissions over user data. In addition, distributing the radio interface and the RBS resources enables users (also be referred to as user devices, user equipments, UEs, or the like) to be multiplexed and scheduled in time and frequency, by efficiently using spectral and hardware resources to optimize user throughput and cell capacity.

The scheduler dynamically performs scheduling, also referred to as dynamic resource allocation, for every transmission time interval, TTI, of 1 ms in a standard LTE system. For every upcoming TTI, the RAN determines the users that are assigned radio interface and the RBS resources.

For a more evolved LTE system or a system involving NR technology, the TTIs in question may be of varying size and shorter than 1 ms.

The scheduler takes into account multiple inputs when determining at least one of: which users to schedule, the amount of resources to allocate per user, what transport block size, TBS, and transport format to use per user device, or the like, for the upcoming TTI. Examples of the inputs may include, but are not limited to, channel quality information, CQI, reported by the user, acknowledgments, ACKs, or negative acknowledgments, NACKs, amount of data each user wants to transfer, available uplink, UL,/downlink, DL, bandwidth, bearer priority, QoS class identifier, QCI, or the like.

A main functionality of the scheduler is to maximize a number of users that fulfill the Qos requirements and to maximize spectrum/resource efficiency. A following set of scheduling algorithms are used to achieve that:
Round-Robin scheduling algorithm: The scheduler distributes a same number of resource blocks to all users. It is simple but it can lead to very unfair resource allocation, where the users positioned at the cell edge obtain the same number of resources than central users, resulting in massive difference in terms of throughput.
Proportional fair scheduling algorithm: The scheduler addresses the main drawback of the round-robin scheduler, i.e., fairness. The scheduler allocates resources to the users according to a priority mechanism. The priority of a user is inversely proportional to the amount of data the user could transmit in previous communication phases.

Scheduling according to the priority mechanism makes sure that all users are treated fairly in terms of throughput and not allocated resources.
Delay based scheduler: The scheduler is mainly designed for voice over Internet protocol, VoIP services, or conversational video services. Such services have a characteristic that the QoS may be degraded dramatically when the packet exceeds its PDB, but no improvement from an even faster arrival time than the PDB. The scheduler utilizes the characteristics associated with the VoIP services/conversational video services to enhance spectrum efficiency in a mixed scenario with both best effort services and VoIP services. The best effort service refers to an Internet delivery service where a provider does not give any guarantees on when the packet will be delivered or the QoS of that packet when it is delivered. The scheduler allocates the resources to the best effort services before the users using the VoIP reach the PDB and allocates the resources to the users using the VoIP services when their PDB is in danger of being violated. With this way, the scheduler is able to maximize throughput for the best effort services while securing the PDB for the VoIP services at the same time.

In view of the above, the scheduler can allocate radio resources to the users in accordance with one or more of: a uniform allocation method (i.e., round-robin scheduling algorithm), a priority mechanism, and a delay mechanism based on characteristics of services. However, the scheduler does not consider certain reliability requirements associated with each packet while allocating the radio resources for transmission of the packet to the users. As a result, aggregated reliability and robustness requirements may not be achieved across multiple transmissions of packets to the users. Thereby, further increasing consecutive packet loss (i.e., unsuccessful delivery of consecutive packets to the users).

### SUMMARY

Consequently, there is a need for an improved method and arrangement for performing transmission of data to a wireless device by improving radio resource allocation that alleviates at least some of the above cited problems.

It is therefore an object of the present disclosure to provide a method, a network node, and a computer program product for performing transmission of data packets to a wireless device, to mitigate, alleviate, or eliminate all or at least some of the above-discussed drawbacks of presently known solutions.

This and other objects are achieved by means of a method, a network node, and a computer program product as defined in the appended claims. The term exemplary is in the present context to be understood as serving as an instance, example or illustration.

According to a first aspect of the present disclosure, a method performed by a network node for transmission of data packets to a wireless device is provided. The method comprises obtaining a packet delay budget, PDB, wherein the PDB represents a maximum allowable delay for a data packet. The method comprises determining a total delay time interval indicating a delay incurred for an estimated number of consecutive data packets transmitted from the network node to the wireless device. The method comprises transmitting the data packets to the wireless device based on if the determined total delay time interval exceeds the obtained PDB or not.

In some embodiments, the step of transmitting the data packets to the wireless device comprises selecting, when determined that the total delay time interval exceeds the PDB, at least one transmission parameter for transmitting the data packets to the wireless device. The method comprises adjusting a block error rate, BLER to a first BLER target of the data packets according to the selected at least one transmission parameter. The method comprises transmitting the data packets to the wireless device with the first BLER target.

In some embodiments, the transmission parameter comprises one or more of: a modulation and coding scheme, MCS, number of resource blocks, and a transmit power.

In some embodiments, the total delay time interval comprises one or more of: a scheduling delay indicating a difference between pre-determined time interval and actual time interval of transmission of each data packet to the wireless device, a hybrid automatic repeat request, HARQ, round time trip, RTT, associated with retransmission of each data packet to the wireless device, a delay associated with reception of acknowledgment and negative acknowledgment, A/N, from the wireless device, and a decoding delay indicating time taken by the network node to decode reception of the A/N.

In some embodiments, the step of transmitting the data packets to the wireless device comprises determining, when determined that the total delay time interval do not exceed the PDB, a reliability requirement indicating a survival time window for which a quality of service, Qos, has to be fulfilled for transmitting the data packets to the wireless device. The method comprises determining, according to the determined reliability requirement, a second BLER target of the data packets to be received by the wireless device within the survival time window. The method comprises transmitting the data packets to the wireless device with the second BLER target of the data packets.

In some embodiments, the step of determining the reliability requirement for transmitting the data packets to the wireless device comprises determining that a remaining PDB of at least one previously transmitted data packet is not within an allowed time interval for retransmission of the at least one previously transmitted data packet. The method comprises estimating a number of remaining transmissions of the data packets to be transmitted within the survival time window, when it has been determined that the remaining PDB of the at least one previously transmitted data packet is not within the allowed time interval for retransmission. The method comprises determining the reliability requirement based on the estimated number of remaining transmissions.

In some embodiments, the step of transmitting the data packets to the wireless device comprises selecting one or more of: a MCS, number of resource blocks, and transmit power based on the reliability requirement for transmitting the data packets.

According to a second aspect of the present disclosure, an apparatus of a network node configured to perform transmission of data packets to a wireless device is provided. The apparatus comprising a controlling circuitry configured to cause obtaining of a packet delay budget, PDB, wherein the PDB represents a maximum allowable delay for a data packet. The controlling circuitry is configured to cause determination of a total delay time interval indicating a delay incurred for an estimated number of consecutive data packets transmitted from the network node to the wireless device. The controlling circuitry is configured to cause transmission of the data packets to the wireless device based on if the determined total delay time interval exceeds the obtained PDB or not.

A third aspect is a network node comprising the apparatus of the second aspect.

According to a fourth aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for performing transmission of the data packets to the wireless device by identifying a relation between the PDB and the total delay time interval and thus emphasizing an importance of a condition when the reliability requirement for the data packet is determined using a survival time. As a result, radio resource allocation may be improved. In addition, aggregated reliability and robustness requirements may be achieved across multiple transmissions of the data packets belonging to a same data flow.

An advantage of some embodiments is that when the total delay time interval exceeds the PDB, the BLER is adjusted to the first BLER target of the data packets (i.e., a low BLER is enabled) and then the data packets are transmitted. As a result, the data packets may be transmitted to the wireless device with reliable transmission.

An advantage of some embodiments is that when the total delay time interval do not exceed the PDB, the second BLER target of the data packets may be determined for the data packets based on the determined reliability requirement. As a result, a rate of successful delivery of the data packets to the wireless device may be improved by reducing consecutive packet loss.

An advantage of some embodiments is that transmitting the data packet based on the PDB, the total delay time interval and the survival time, determines a link adaptation method for an application supporting ultra-reliable low latency communications, URLLC, service while using the survival time. As a result, the robustness of individual transmissions/data packet belonging to the same data flow may be adjusted to successfully deliver at least one data packet during a given time interval.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates examples of how two different applications experience a same sequence of events;

FIG. 2 discloses an example wireless communication system according to some embodiments;

FIG. 3 is a flowchart illustrating example method steps according to some embodiments;

FIG. 4 is a flowchart illustrating example method steps according to some embodiments;

FIG. 5 is a schematic block diagram illustrating an example apparatus according to some embodiments;

FIG. 6 is a block diagram of a telecommunication network connected via an intermediate network to a host computer, according to some embodiments;

FIG. 7 is a block diagram of a host computer communicating via a base station with a user equipment, UE, over a partially wireless connection, according to some embodiments;

FIG. 8 is a block diagram of methods implemented in a communication system including a host computer, a base station, and a UE, according to some embodiments;

FIG. 9 is a block diagram of methods implemented in a communication system including a host computer, a base station, and a UE, according to some embodiments;

FIG. 10 is a block diagram of methods implemented in a communication system including a host computer, a base station, and a UE, according to some embodiments;

FIG. 11 is a block diagram of methods implemented in a communication system including a host computer, a base station, and a UE, according to some embodiments; and

FIG. 12 discloses an example computing environment according to some embodiments.

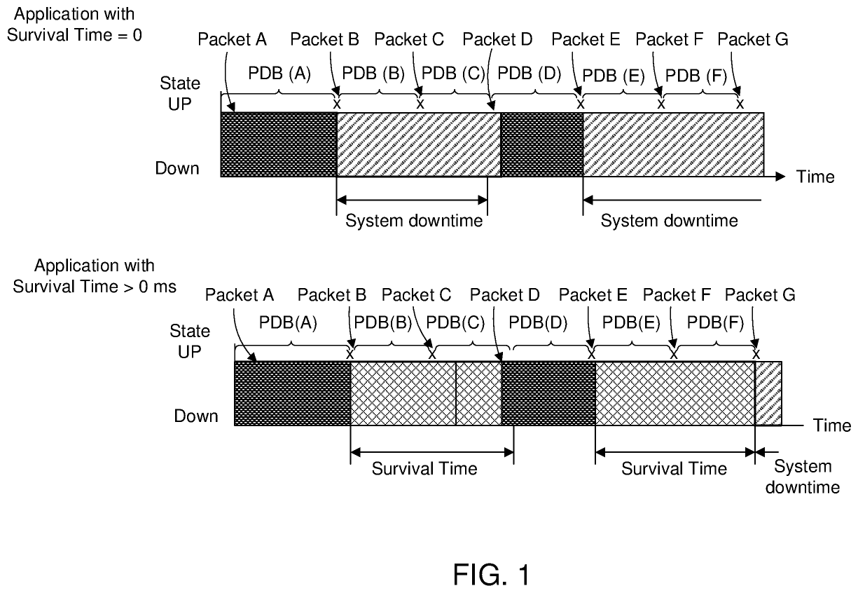

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

In some embodiments, a more general term “network node” may be used and may correspond to any type of radio network node or any network node, which communicates with a user equipment, UE, (directly or via another node) and/or with another network node. Examples of network nodes are a radio access network, RAN, a NodeB, a MeNB, a ENB, a network node belonging to a master cell group, MCG, or a secondary cell group, SCG, a base station, BS, and a multi-standard radio, MSR, a radio node such as a MSR BS, an eNodeB, a gNodeB, a network controller, a radio network controller, RNC, a base station controller, BSC, a relay, a donor node controlling relay, a base transceiver station, BTS, access points, APs, transmission points, transmission nodes, a remote radio unit, RRU, and a remote radio head, RRH, nodes in distributed antenna system, DAS, a core network node (for example, a mobile switching center, MSC, a mobility management entity, MME, or the like), an operation & management, O&M, node, an operations support system, OSS, node a self-optimized network, SON, a positioning node (for example, an evolved serving mobile location center, E-SMLC), a minimization drive test, MDT, test equipment (for example, a physical node or software), and so on.

In some embodiments, a non-limiting term user equipment, UE, or a wireless device may be used and may refer to any type of wireless device communicating with a network node and/or with another UE in a wireless communication system. Examples of the UE are a target device, a device to device, D2D, UE, a machine type UE, a UE capable of machine to machine, M2M, communication, personal digital assistant, PDA, tablet, mobile terminals, smart phone, laptop embedded equipped, LEE, laptop mounted equipment, LME, universal serial bus, USB, dongles, UE category M2, ProSe UE, vehicle-to-vehicle, V2V, UE, vehicle-to-everything, V2X UE, and so on.

Additionally, terminologies such as base station/gNodeB, and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

Certain embodiments apply methods to reduce a risk of consecutive data packet loss (which industrial applications are sensitive to) beyond what is supported with existing link adaptation mechanisms. The industrial applications are particularly sensitive to consecutive data packet loss. This means that industrial applications may perceive a higher reliability in terms of data packet delivery as compared to a system, which does not apply methods to reduce consecutive data packet loss.

According to certain embodiments, some assumptions may be applicable:
RAN is for a specific data flow aware of a packet delay budget, PDB, and a required reliability in terms of maximum number of consecutive data packets that may be lost by means of, for example, but not limited to, standards, configuration (for example, as part of quality control information, quality of service, Qos, class identifier, QCI, 5G QoS identifier, 5QI, profile, signalled as a specific information element, IE, from a core network, CN, to the RAN), machine learning, and so on.
The techniques described herein apply to both application messages segmented or not segmented within the RAN (for example, by gNB or eNB).
Re-transmissions when stated below may refer to re-transmissions performed by the RAN such as, for example, packet data convergence protocol, PDCP, hybrid automatic repeat request, HARQ, radio link control, RLC, retransmissions.
A survival time window mentioned below corresponds to a transfer time or a packet delay budget, PDB, of a single application packet plus a survival time of the application. Within the survival time window at least one application packet has to be successfully delivered for the application to not consider a communication service to be down.
In one example, the survival time of the industrial application is provided to the RAN as a part of a QCI profile configuration associated with a bearer that is setup to carry the associated application traffic.

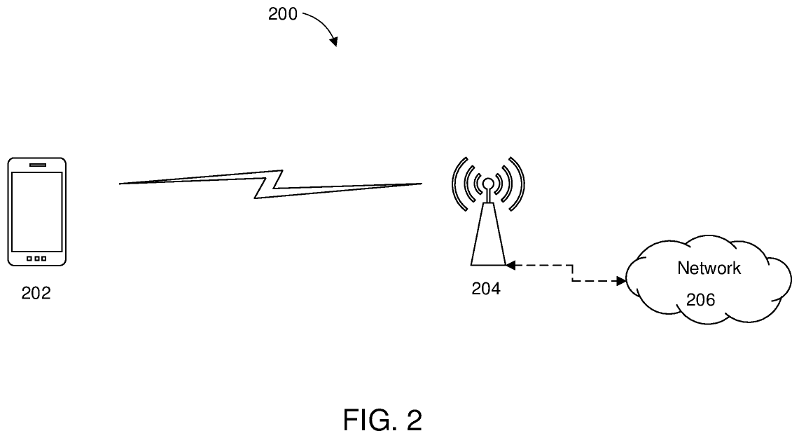

FIG. 2 discloses an example wireless communication system 200. Although the subject matter described herein may be implemented in any appropriate type of system using any suitable components, the embodiments disclosed herein are described in related to a wireless communication system/wireless network, such as the example wireless communication system 200 described in FIG. 2. The wireless communication system 200 may comprise and/or interface with any type of communication, telecommunication, data, cellular, and/or radio network or other similar type of system. In some embodiments, the wireless communication system 200 may be configured to operate according to specific standards or other types of predefined rules of procedures. Thus, particular embodiments of the wireless communication system 200 may implement communication standards, such as, but are not limited to, global system for mobile communications, GSM, universal mobile telecommunications system, UMTS, long term evolution, LTE, and/or other suitable 2G, 3G, 4G, or 5G standards, wireless local area network, WLAN, standards such as, IEEE 802.11 standards, and/or any other appropriate wireless communication standards, such as, worldwide interoperability for microwave access, WiMax, Bluetooth, Z-Wave and/or ZigBee standards. The wireless communication system 200 may provide communication and other type of services to one or more wireless devices to facilitate the wireless devices' access to and/or use of the services provided by, or via, the wireless communication system 200.

For simplicity, as depicted in FIG. 2, the wireless communication system 200 comprises a wireless device 202, a network node 204, and a network 206. The wireless device 202 and the network node 204 operate together in order to provide wireless connections in the wireless communication system 200. The network 206 may comprise one or more backhaul networks, core networks, IP networks, public switched telephone networks, PSTNs, packet data networks, optical networks, wide-area networks, WANs, local area networks, LANs, wireless local area networks, WLANs, wired networks, wireless networks, metropolitan area networks, and other networks to enable communication between devices (for example, wireless devices and network node).

In practice, the wireless communication system 200 may further include any additional elements suitable to support communication between wireless devices or between a wireless device and another communication device, such as a landline telephone, a service provider, or any other network node or end device. In different embodiments, the wireless communication system 200 may comprise any number of wired or wireless networks, network nodes, base stations, controllers, wireless devices, relay stations, and/or any other components or systems that may facilitate or participate in the communication of data and/or signals whether via wired or wireless connections.

The wireless device 202 refers to a device capable, configured, arranged and/or operable to communicate wirelessly with network nodes and/or other wireless devices. Unless otherwise noted, the term “wireless device” may be used interchangeably herein with user equipment, UE. Communicating wirelessly may involve transmitting and/or receiving wireless signals using electromagnetic waves, radio waves, infrared waves, and/or other types of signals suitable for conveying information through air.

In some embodiments, the wireless device 202 may be configured to transmit data packets to the network node 204 or receive the data packets from the network node 204. The data packets may also be referred to as, application messages, or the like. For instance, the wireless device 202 may transmit the data packets to the network node 204 on a pre-determined schedule, when triggered by an internal or an external event, or in response to requests received from the network node 204. Each data packet indicates one or more of: a command, information, a signal, or the like.

Examples of the wireless device 202 may include, but are not limited to, a smart phone, a mobile phone, a cell phone, a voice over Internet Protocol, IP, VoIP, phone, a wireless local loop phone, a desktop computer, a personal digital assistant, PDA, a wireless camera, a gaming console or device, a music storage device, a playback appliance, a wearable terminal device, a wireless endpoint, a mobile station, a tablet, a laptop, a laptop-embedded equipment, LEE, a laptop-mounted equipment, LME, a smart device, a wireless customer-premise equipment, CPE, a vehicle-mounted wireless terminal device, and so on.

In some examples, the wireless device 202 may support device-to-device, D2D, communication, for example by implementing a 3GPP standard for side link communication, vehicle-to-vehicle, V2V, vehicle-to-infrastructure, V21, vehicle-to-everything, V2X, and may in this case be referred to as a D2D communication device. In some other examples, in an Internet of Things, IoT, scenario, the wireless device 202 may represent a machine or other device that performs monitoring and/or measurements and transmits results of such monitoring and/or measurements to another wireless device and/or the network node 204. The wireless device 202 may in this case be a machine-to-machine, M2M device, which may in a 3GPP context be referred to as an MTC device. In some other examples, the wireless device 202 may be a UE implementing 3GPP narrow band IoT, NB-IoT standard. Particular examples of such machines or devices are sensors, metering devices such as power meters, industrial machinery, or home or personal appliances (for example, refrigerators, televisions, or the like) personal wearables (for example, watches, fitness trackers, or the like). In some other examples, the wireless device 202 may represent a vehicle or other equipment that is capable of monitoring and/or reporting on its operational status or other functions associated with its operation. The wireless device 202 as described above may represent the endpoint of a wireless connection, in which case the device may be referred to as a wireless terminal. Furthermore, a wireless device as described above may be mobile, in which case it may also be referred to as a mobile device or a mobile terminal.

The network node 204 refers to equipment capable, configured, arranged, and/or operable to communicate directly or indirectly with the wireless device 202 and/or with other network nodes or equipment in the wireless communication system 200 to enable and/or provide wireless access to the wireless device 202 and/or to perform other functions (for example, administration) in the wireless communication system 200. Examples of the network node 204 may include, but are not limited to, access points, APs (for example, radio access points), base stations, BSs (for example, radio base stations, nodeBs, evolved NodeBs, eNBs, new radio, NR, nodes (gNBs), or the like). The BSs may be categorized based on an amount of coverage the BSs provide (or, stated different, their transmit power level) and may then also be referred to as femto BSs, pico BSs, micro BSs, macro BSs. The BS may be a relay node or a relay donor node controlling a relay.

In some other examples, the network node 204 may also include one or more (or all) parts of a distributed radio base station such as centralized digital units and/or remote radio units, RRUs, sometimes referred to as remote radio heads, RRHs. Such remote radio units may or may not be integrated with an antenna as an antenna integrated radio. Parts of a distributed radio base station may also be referred to as nodes in a distributed antenna system, DAS.

In some other examples, the network node 204 may also include multi-standard radio, MSR, equipment such as, MSR BSs, network controllers such as radio network controllers, RNCs, or base station controller, BSCs, base transceiver stations, BTSs, transmission points, transmission nodes, multi-cell/multicast coordination entities, MCEs, core network nodes (for example, mobile switching centres, MSCs, mobility management entities, MMEs, or the like), operation & management, O&M, nodes, operations support system, OSS, nodes, self-organizing network, SON, nodes, positioning nodes (for example, E-SMLCs) and/or minimization drive test, MDT, test equipment.

More generally, the network node 204 may represent any suitable device (or group of devices) capable, configured, arranged, and/or operable to enable and/or provide the wireless device 202 with access to the wireless communication system 200 or to provide some service (referred to as a communication service) to the wireless device 202 that has accessed the wireless communication system 200.

The network node 204 may also be configured to transmit the data packets to the wireless device 202 or receive the data packets from the wireless device 202. In some examples, the data packet may be associated with a data flow of an application. Examples of the application may include, but are not limited to, an industrial applications, or any other application that supports ultra-reliable low latency communications, URLLC or any industrial system. Many industrial applications are non-adaptive control systems with strict network performance requirements. Some industrial applications will consider the communication system to be unavailable if it does not fulfill the quality of service required by the application. In some examples, the application may be associated with communication system reliability requirements/quality of service, Qos, requirements. The requirements of the system reliability herein may indicate a survival time window during which a desired level of QoS has to be fulfilled. Fulfilling the QoS refers to successful delivery of at least one data packet during the survival window. For the data packets, the requirements are usually expressed as a target reliability calculated as a percentage value of the amount of sent data packets successfully delivered within the packet delay budget required by a targeted application, divided by the total number of sent data packets.

Within the survival time window at least one data packet has to be successfully delivered for the application to not to consider the communication service/network node 204 to be down. The survival time window refers to a sum of a transfer time or a packet delay budget, PDB, of a single application/data packet and a survival time of the application. The PDB indicates a maximum allowable delay for the data packet. The survival time of the application may be a time period during which the application may manage some packet loss (i.e., unsuccessful delivery of packets) without performing any emergency actions (for example, emergency shut-down, production stop, or the like). The survival time depends on an implementation of the application and differs between industries and use cases. For example, the survival time may vary from 0 milliseconds, ms, to 25 ms.

The network node 204 may transmit/schedule the data to the wireless device 202 using:
a same amount of radio resources that have been allocated for other wireless devices; or
the radio resources allocated based on a priority mechanism; or.
the radio resources allocated based on a delay mechanism, which is dependent on characteristics of services (for example, VoIP services, conversational services) being supported by the wireless device.

However, the network node 204 does not consider the reliability requirements, robustness requirements, or the like while performing transmission of the data packets to the wireless device 202. Thus, aggregated reliability and robustness requirements may not be achieved across multiple transmissions of data packets to the wireless device 202. As a result, consecutive data packet loss (i.e., unsuccessful delivery of consecutive data packets to the wireless device 202) may be increased.

Therefore, according to some embodiments of the present disclosure, the network node 204 implements a method for improving scheduling of transmission of data packets to the wireless device 202.

According to some embodiments of the present disclosure, the network node 204 obtains a PDB. The PDB represents a maximum allowable delay for the data packet. The network node 204 determines the total delay time interval indicating a delay incurred for an estimated number of consecutive data packets transmitted from the network node 204 to the wireless device 202. The network node 204 transmits the data packets to the wireless device based on if the determined total delay time interval exceeds the obtained PDB or not. Thus, from such a transmission, aggregated reliability and robustness requirements may be achieved across multiple transmissions of data packets to the wireless device 202 and the consecutive packet loss may be reduced.

Various embodiments for performing transmission of the data packets to the wireless device 202 are explained in conjunction with figures in the later parts of the description.

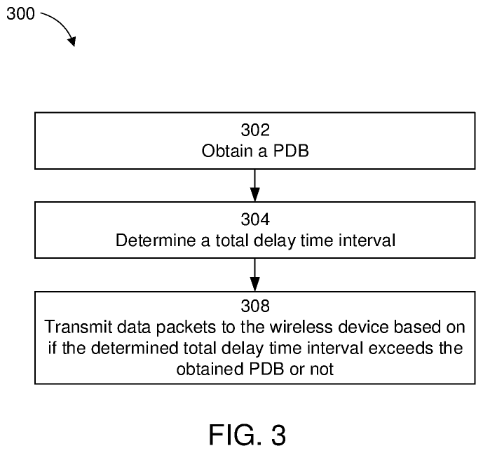

FIG. 3 is a flowchart illustrating example method steps of a method 300 performed by the network node for transmitting data packets to the wireless device. In some examples, the data packet may be a new data packet within a same data flow of an application including at least one previously transmitted data packet. In some examples, the application may support a feature of survival time. The survival time indicates how tolerant the application is to unsuccessful packet deliver, which is partly governed by how many consecutive lost application packets that application may accept before performing one or more emergency actions, such as, for example, emergency shut-down and production stop.

At step 302, the method 300 comprises obtaining a PDB. The PDB represents a maximum allowable delay for the data packet. In some embodiments, the network node may be pre-configured of the PDB.

At step 304, the method 300 comprises determining a total delay time interval indicating a delay incurred for an estimated number of consecutive data packets transmitted from the network node to the wireless device.

In some examples, the network node may estimate the number of consecutive data packets for which the total delay time interval has to be determined, based on the survival time. The survival time may be associated with the application to which the data packet to be transmitted to the wireless device belongs to. The network node may obtain information about the survival time as a part of a QoS class identifier, QCI, profile configuration associated with a bearer that is setup to carry the associated packet/application traffic. Estimation of the number of consecutive data packets for which the total delay time interval has to be determined may vary based on the survival time. In some examples, the number of consecutive packets for which the total delay time interval has to be determined may be three (3), when the survival time associated with the application is greater than Oms and the application tolerates two consecutive packet loss.

In some embodiments, the total delay time interval may comprise one or more of: a scheduling delay, a hybrid automatic repeat request, HARQ, round time trip, HARQ RTT, a reception delay, and a decoding delay. The scheduling delay indicates a difference between pre-determined time interval and actual time interval of transmission of each data packet to the wireless device. The HARQ RTT may be associated with retransmission of each data packet from the network node to the wireless device. The reception delay may indicate a delay associated with reception of acknowledgment and negative acknowledgement, A/N, from the wireless device. The decoding delay indicates time taken by the network node to decode reception of the A/N.

Upon obtaining the PDB and determining the total delay time interval, at step 308, the method 300 comprises transmitting the data packets to the wireless device based on if the determined total delay time interval exceeds the obtained PDB or not.

When it has been determined that the total time interval exceeds the PDB, the step 308 of transmitting the data packets to the wireless device may comprise selecting at least one transmission parameter for transmitting the data packets to the wireless device. In some examples, the transmission parameter may comprise one or more of: a modulation and coding scheme, MCS, a number of resource blocks, and transmit power.

Upon selecting the at least one transmission parameter, the method may comprise adjusting a block error rate, BLER of the data packets to a first BLER target of the data packets, according to the selected at least one transmission parameter. The first BLER target of the data packet may represent a decoding failure rate of the data packets. In some examples, the first BLER target may be set as 10%, but the BLER target may be varied depending on characteristics of a cell served by the network node. For instance, if the first BLER target is 10%, which means that the receiver (for example, the wireless device) has to receive at least 90% successful transmission.

In some examples, adjusting the BLER to the first BLER target of the data packets may involve reducing the BLER of the data packets to meet the first BLER target while transmitting the data packets to the wireless device. Thereby, transmitting the data packets to the wireless device with low BLER.

When it has been determined that the total time interval do not exceed the PDB, the step 308 of transmitting the data packets to the wireless device may comprise determining a reliability requirement indicating a survival time window for which a QoS has to be fulfilled for transmitting the data packets to the wireless device. The survival time window corresponds to a sum of a transfer time or a PDB of a single application packet and the survival time of the application. Within the survival time window at least one application packet has to be successfully delivered for the application to not consider the communication service/network node to be down. Fulfilling the QoS herein may refer to successfully delivering the at least one data packet within the survival time window.

In some embodiments, the step of determining the reliability may comprise determining that a remaining PDB of at least one previously transmitted data packet is not within an allowed time interval for retransmission of the at least one previously transmitted data packet. The remaining PDB may identify a remaining length of the time in which the at least one previously transmitted data packet may be retransmitted based on a negative acknowledgment, NACK, received from the wireless device. The allowed time interval for retransmission of the at least one previously transmitted data packet may refer to a time interval for retransmission of the at least one previously transmitted data packet. When it has been determined that the remaining PDB of the at least one previously transmitted data packet is not within the allowed time interval for retransmission, the method may comprise determining an estimated number of remaining transmissions of the data packets to be transmitted within the survival time window. The method may further comprise determining the reliability requirement based on the estimated number of remaining transmissions.

In some examples, if there is a HARQ NACK obtained for a data packet, the network node evaluates the remaining PDB of the previously transmitted data packet for retransmission. If the remaining PDB is not within the allowed time interval, the network node handles the retransmission of the previously transmitted data packet and transmission of other data packets based on the survival time (i.e., determining the reliability requirement for transmitting the data packets). In an example with respect to retransmissions, if the remaining PDB of the previously transmitted data packet is not within the allowed time interval for retransmission and if the survival time is sufficient, then the HARQ retransmission is ignored. In another example with respect to transmission of the other data packets, if the remaining PDB of the previously transmitted data packet is not within the allowed time interval for retransmission, the network node determines the reliability requirement based on the estimated number of remaining transmissions of the data packets to be transmitted within the survival window. The network node transmits other data packets to the wireless device based on the determined reliability requirement.

Upon determining the reliability requirement, the method may comprise determining the second BLER target of the data packets based on the reliability requirement. The method comprises transmitting the data packets to the wireless device based on the second BLER target of the data packets. More Details related to determining the reliability requirement can be found in the International Publication No. WO 2020/167231 A1.

Optionally, the step of transmitting the data packets to the wireless device may comprise selecting one or more of: a MCS, a number of resource blocks, and transmit power based on the reliability requirement for transmitting the data packets, when it has been determined that the total time interval do not exceed the PDB.

Thus, transmitting the data packets either by adjusting the BLER of the data packets to the first BLER or based on the second BLER target of the data packets determined using the reliability requirement achieves aggregated reliability and robustness across multiple transmissions of the packets.

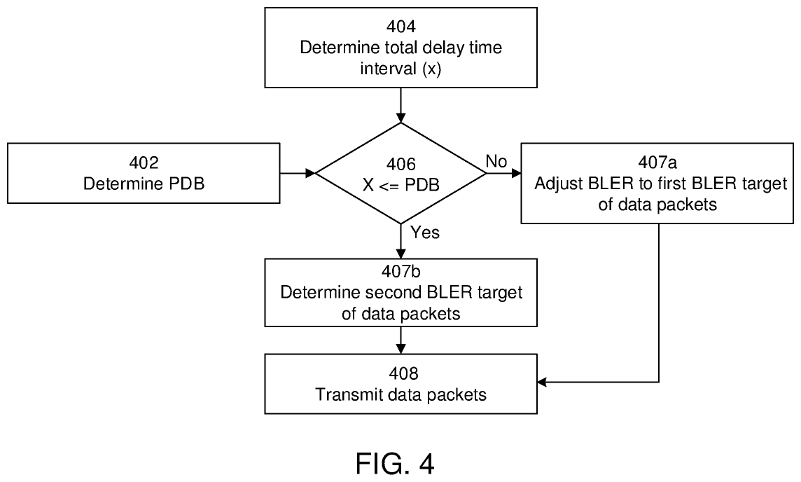

FIG. 4 is a flowchart illustrating example method steps performed by the network node for transmitting data comprising one or more packets to the wireless device.

At step 402, the network node determines a PDB, which represents a maximum allowable delay for the data packet.

At step 404, the network node determines a total delay time interval (for example, represented as ‘X’ in FIG. 4). The total delay time interval indicates a delay incurred for the estimated number of consecutive data packets transmitted from the network node to the wireless device. In an embodiment, the total delay time interval comprises one or more of: a scheduling delay indicating a difference between pre-determined time interval and actual time interval of transmission of each data packet to the wireless device, a HARQ RTT, associated with retransmission of each data packet to the wireless device, a delay associated with reception of A/N from the wireless device, and a decoding delay indicating time taken by the network node to decode reception of the A/N.

At step 406, the network node determines whether the total delay time interval exceeds the PDB or not.

When it has been determined that the total delay time interval exceeds the PDB, at step 407a, the network node adjusts a BLER of the data packets to the first BLER target of the data packets, according to at least one selected transmission parameter for transmitting the data packets to the wireless device. In some embodiments, the transmission parameter comprises one or more of: a MCS, a number of resource blocks, and transmit power.

When it has been determined that the total delay time do not exceed the PDB, at step 407b, the network node determines the second BLER target of the data packets based on a reliability requirement indicating a survival time window for which a Qos has to be fulfilled (i.e., successfully delivering the at least one data packet within the survival time window). The reliability requirement may be determined based on the estimated number of remaining transmissions to be transmitted within the survival time window, when a remaining PDB of at least one previously transmitted data packet is not within an allowed time interval for retransmission of the at least one previously transmitted data packet.

At step 408, the network node transmits the data packet to the wireless device with either the first BLER target of the data packets or the second BLER target of the data packets and the selected at least one transmission parameter according to the determined reliability requirement.

In an example, consider that the network node selects at least one transmission parameter and adjusts the BLER to the first BLER target of the data packets at step 407a. In such a scenario, the network node transmits the packet to the wireless device by setting a low BLER. In some examples, setting of the low BLER may depend on at least one of: a length of the survival time, or the like. For instance, the BLER may be set as (1—initial reliability target/requirement). Thus, the packet may be transmitted to the wireless device with the reliable BLER, since no feedback is available.

In another example, consider that the network node determines the reliability requirement for transmitting the packet, at step 407b. In such a scenario, the network node transmits the packet to the wireless device by determining the second BLER target of the data packets and then the network node selects, a MCS, number of resource blocks, and a transmit power (based on the determined reliability requirement). Thus, the transmissions may be performed by improving rate of successful deliver of the packets to the wireless device.

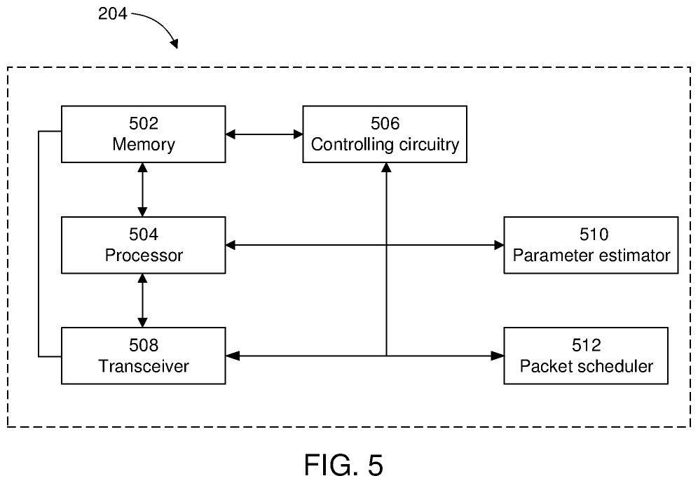

FIG. 5 is an example schematic diagram showing an apparatus 204. The apparatus 204 may e.g. be comprised in a network node. The apparatus 204 is capable of performing transmission of data packets to the wireless device and may be configured to cause performance of the method 300 for transmission of data to the wireless device.

According to at least some embodiments of the present invention, the apparatus 204 in FIG. 5 comprises one or more modules. These modules may e.g. be a memory 502, a processor 504, a controlling circuitry 506, a transceiver 508, a parameter estimator 510, and a packet scheduler 512. The controlling circuitry 506, may in some embodiments be adapted to control the above mentioned modules.

The memory 502, the processor 504, the transceiver 508, the parameter estimator 510, and the packet scheduler 512 as well as the controlling circuitry 506, may be operatively connected to each other.

The controlling circuitry 506 may be adapted to control the steps as executed by the network node. For example, the controlling circuitry 506 may be adapted to perform transmission of the data packets to the wireless device (as described above in conjunction with the method 300 and FIG. 3).

The parameter estimator 510 may be adapted to obtain a PDB, which indicates a maximum allowable delay for the packet. The parameter estimator 510 may also be adapted to determine a total delay time interval indicating a delay incurred for an estimated number of consecutive data packets transmitted from the network node to the wireless device.

The packet scheduler 512 may be adapted to determine whether the total delay time interval exceeds the PDB or not and accordingly enables transmission of the packet to the wireless device. In some embodiments, the packet scheduler 512 may be adapted to adjust a BLER to the first BLER target of the data packets according to the selected at least one transmission parameter, when the total delay time interval exceeds the PDB. In some embodiments, the packet scheduler 512 may be adapted to determine the second BLER target of the data packets for transmitting the data packets based on the reliability requirement, when the total delay time interval do not exceed the PDB.

The transceiver 508 may be adapted to transmit the data packets to the wireless device. In some embodiments, the packets may be transmitted based on the first BLER target of the data packets. In some embodiments, the packet may be transmitted based on the second BLER target of the data packets.

The processor 504 may be adapted to determine the reliability requirement.

Further, the memory 502 is adapted to store the PDB, the total delay time interval, the transmission parameters, the BLER target of the data packets, the reliability requirement, or the like.

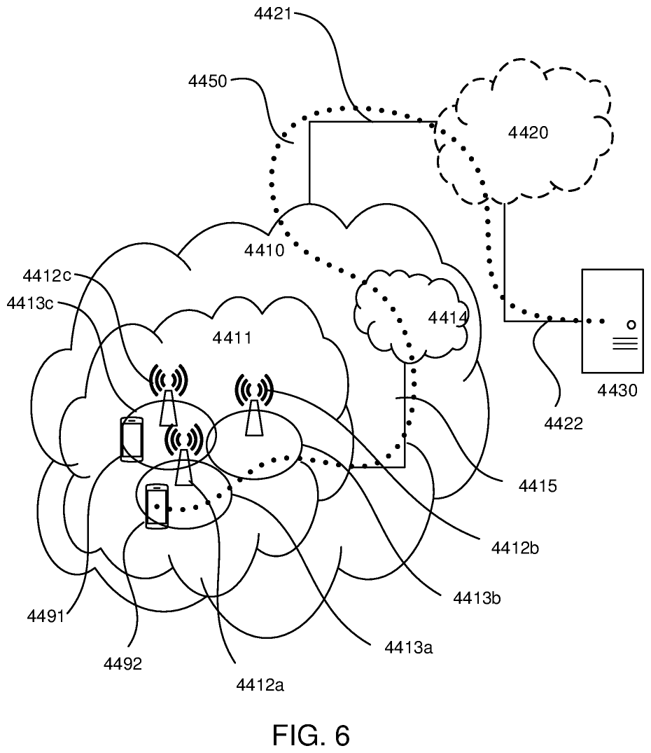

FIG. 6 is a block diagram of a telecommunication network connected via an intermediate network to a host computer according to some embodiments. With reference to FIG. 6, in accordance with an embodiment, a communication system includes telecommunication network 4410, such as a 3GPP-type cellular network, which comprises access network 4411, such as a radio access network, and core network 4414. Access network 4411 comprises a plurality of base stations 4412a, 4412b, 4412c, such as NBs, eNBs, gNBs or other types of wireless access points, each defining a corresponding coverage area 4413a, 4413b, 4413c. Each base station 4412a, 4412b, 4412c is connectable to core network 4414 over a wired or wireless connection 4415. A first UE 4491 located in coverage area 4413c is configured to wirelessly connect to, or be paged by, the corresponding base station 4412c. A second UE 4492 in coverage area 4413a is wirelessly connectable to the corresponding base station 4412a. While a plurality of UEs 4491, 4492 are illustrated in this example, the disclosed embodiments are equally applicable to a situation where a sole UE is in the coverage area or where a sole UE is connecting to the corresponding base station 4412.

Telecommunication network 4410 is itself connected to host computer 4430, which may be embodied in the hardware and/or software of a standalone server, a cloud-implemented server, a distributed server or as processing resources in a server farm. Host computer 4430 may be under the ownership or control of a service provider, or may be operated by the service provider or on behalf of the service provider. Connections 4421 and 4422 between telecommunication network 4410 and host computer 4430 may extend directly from core network 4414 to host computer 4430 or may go via an optional intermediate network 4420. Intermediate network 4420 may be one of, or a combination of more than one of, a public, private or hosted network; intermediate network 4420, if any, may be a backbone network or the Internet; in particular, intermediate network 4420 may comprise two or more sub-networks (not shown).

The communication system of FIG. 6 as a whole enables connectivity between the connected UEs 4491, 4492 and host computer 4430. The connectivity may be described as an over-the-top, OTT connection 4450. Host computer 4430 and the connected UEs 4491, 4492 are configured to communicate data and/or signaling via OTT connection 4450, using access network 4411, core network 4414, any intermediate network 4420 and possible further infrastructure (not shown) as intermediaries. OTT connection 4450 may be transparent in the sense that the participating communication devices through which OTT connection 4450 passes are unaware of routing of uplink and downlink communications. For example, base station 4412 may not or need not be informed about the past routing of an incoming downlink communication with data originating from host computer 4430 to be forwarded (e.g., handed over) to a connected UE 4491. Similarly, base station 4412 need not be aware of the future routing of an outgoing uplink communication originating from the UE 4491 towards the host computer 4430.

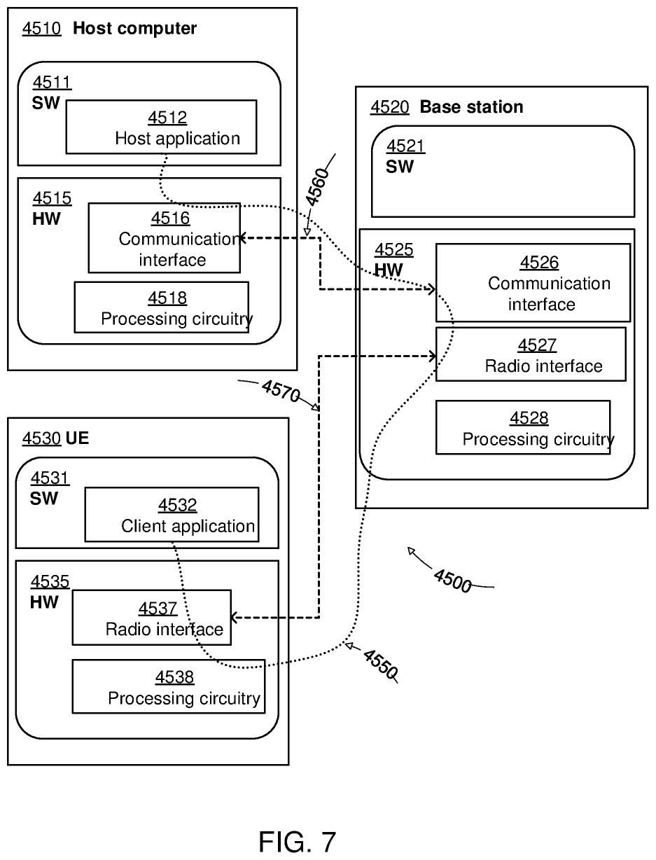

FIG. 7 is a block diagram of a host computer communicating via a base station with a user equipment over a partially wireless connection. Example implementations, in accordance with an embodiment, of the UE, base station and host computer discussed in the preceding paragraphs will now be described with reference to FIG. 7. In communication system 4500, host computer 4510 comprises hardware 4515 including communication interface 4516 configured to set up and maintain a wired or wireless connection with an interface of a different communication device of communication system 4500. Host computer 4510 further comprises processing circuitry 4518, which may have storage and/or processing capabilities.

In particular, processing circuitry 4518 may comprise one or more programmable processors, application-specific integrated circuits, field programmable gate arrays or combinations of these (not shown) adapted to execute instructions. Host computer 4510 further comprises software 4511, which is stored in or accessible by host computer 4510 and executable by processing circuitry 4518. Software 4511 includes host application 4512. Host application 4512 may be operable to provide a service to a remote user, such as UE 4530 connecting via OTT connection 4550 terminating at UE 4530 and host computer 4510. In providing the service to the remote user, host application 4512 may provide user data which is transmitted using OTT connection 4550.

Communication system 4500 further includes base station 4520 provided in a telecommunication system and comprising hardware 4525 enabling it to communicate with host computer 4510 and with UE 4530. Hardware 4525 may include communication interface 4526 for setting up and maintaining a wired or wireless connection with an interface of a different communication device of communication system 4500, as well as radio interface 4527 for setting up and maintaining at least wireless connection 4570 with UE 4530 located in a coverage area (not shown in FIG. 6) served by base station 4520. Communication interface 4526 may be configured to facilitate connection 4560 to host computer 4510. Connection 4560 may be direct or it may pass through a core network (not shown in FIG. 7) of the telecommunication system and/or through one or more intermediate networks outside the telecommunication system. In the embodiment shown, hardware 4525 of base station 4520 further includes processing circuitry 4528, which may comprise one or more programmable processors, application-specific integrated circuits, field programmable gate arrays or combinations of these (not shown) adapted to execute instructions. Base station 4520 further has software 4521 stored internally or accessible via an external connection.

Communication system 4500 further includes UE 4530 already referred to. Its hardware 4535 may include radio interface 4537 configured to set up and maintain wireless connection 4570 with a base station serving a coverage area in which UE 4530 is currently located. Hardware 4535 of UE 4530 further includes processing circuitry 4538, which may comprise one or more programmable processors, application-specific integrated circuits, field programmable gate arrays or combinations of these (not shown) adapted to execute instructions. UE 4530 further comprises software 4531, which is stored in or accessible by UE 4530 and executable by processing circuitry 4538. Software 4531 includes client application 4532. Client application 4532 may be operable to provide a service to a human or non-human user via UE 4530, with the support of host computer 4510. In host computer 4510, an executing host application 4512 may communicate with the executing client application 4532 via OTT connection 4550 terminating at UE 4530 and host computer 4510. In providing the service to the user, client application 4532 may receive request data from host application 4512 and provide user data in response to the request data. OTT connection 4550 may transfer both the request data and the user data. Client application 4532 may interact with the user to generate the user data that it provides.

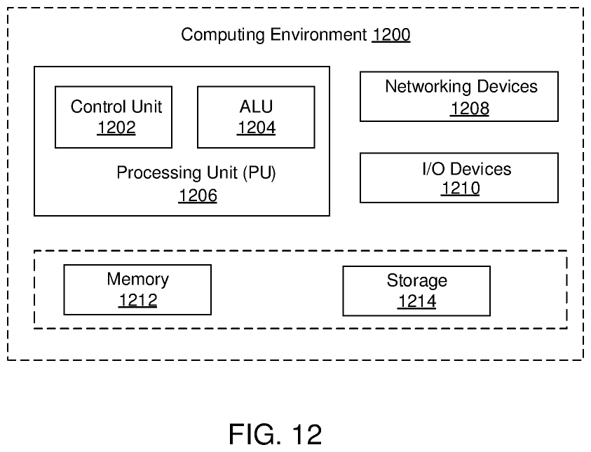

It is noted that host computer 4510, base station 4520 and UE 4530 illustrated in FIG. 9 may be similar or identical to host computer 4430, one of base stations 4412a, 4412b, 4412c and one of UEs 4491, 4492 respectively. This is to say, the inner workings of these entities may be as shown in FIG. 12 and independently, the surrounding network topology may be that of FIG. 7.

In FIG. 7, OTT connection 4550 has been drawn abstractly to illustrate the communication between host computer 4510 and UE 4530 via base station 4520, without explicit reference to any intermediary devices and the precise routing of messages via these devices. Network infrastructure may determine the routing, which it may be configured to hide from UE 4530 or from the service provider operating host computer 4510, or both. While OTT connection 4550 is active, the network infrastructure may further take decisions by which it dynamically changes the routing (e.g., on the basis of load balancing consideration or reconfiguration of the network).

Wireless connection 4570 between UE 4530 and base station 4520 is in accordance with the teachings of the embodiments described throughout this disclosure. One or more of the various embodiments may improve the performance of OTT services provided to UE 4530 using OTT connection 4550, in which wireless connection 4570 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 4550 between host computer 4510 and UE 4530, in response to variations in the measurement results. The measurement procedure and/or the network functionality for reconfiguring OTT connection 4550 may be implemented in software 4511 and hardware 4515 of host computer 4510 or in software 4531 and hardware 4535 of UE 4530, or both. In embodiments, sensors (not shown) may be deployed in or in association with communication devices through which OTT connection 4550 passes; the sensors may participate in the measurement procedure by supplying values of the monitored quantities exemplified above, or supplying values of other physical quantities from which software 4511, 4531 may compute or estimate the monitored quantities. The reconfiguring of OTT connection 4550 may include message format, retransmission settings, preferred routing etc.; the reconfiguring need not affect base station 4520, and it may be unknown or imperceptible to base station 4520. Such procedures and functionalities may be known and practiced in the art. In certain embodiments, measurements may involve proprietary UE signaling facilitating host computer 4510's measurements of throughput, propagation times, latency and the like. The measurements may be implemented in that software 4511 and 4531 causes messages to be transmitted, in particular empty or ‘dummy’ messages, using OTT connection 4550 while it monitors propagation times, errors or the like.

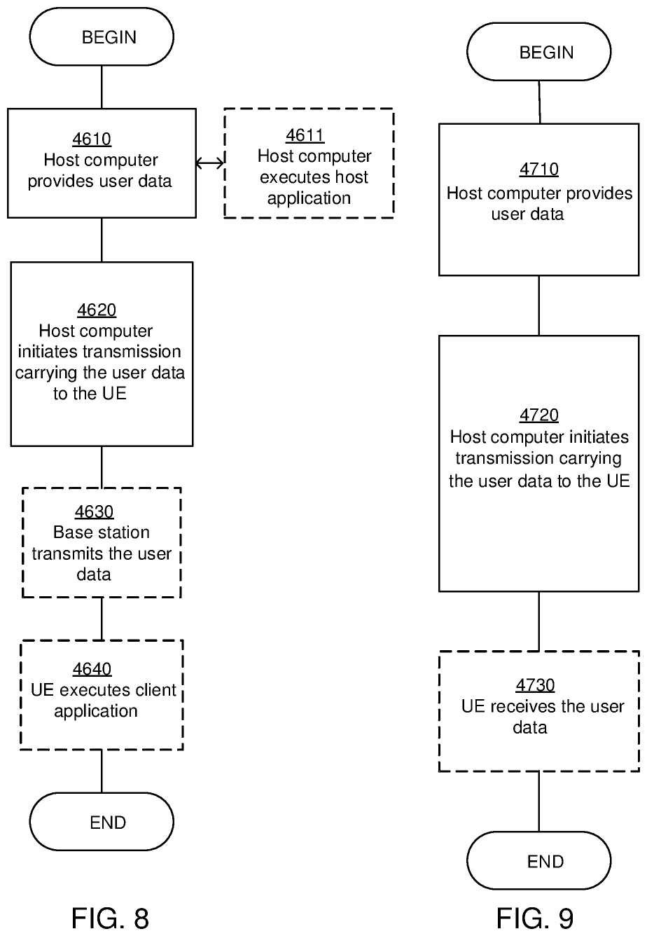

FIG. 8 is a block diagram of methods implemented in a communication system including a host computer, a base station, and a user equipment according to some embodiments. For simplicity of the present disclosure, only drawing references to FIG. 8 will be included in this section. In step 4610, the host computer provides user data. In substep 4611 (which may be optional) of step 4610, the host computer provides the user data by executing a host application. In step 4620, the host computer initiates a transmission carrying the user data to the UE. In step 4630 (which may be optional), the base station transmits to the UE the user data which was carried in the transmission that the host computer initiated, in accordance with the teachings of the embodiments described throughout this disclosure. In step 4640 (which may also be optional), the UE executes a client application associated with the host application executed by the host computer.

FIG. 9 is a block diagram of methods implemented in a communication system including a host computer, a base station, and a user equipment according to some embodiments. For simplicity of the present disclosure, only drawing references to FIG. 9 will be included in this section. In step 4710 of the method, the host computer provides user data. In an optional substep (not shown) the host computer provides the user data by executing a host application. In step 4720, the host computer initiates a transmission carrying the user data to the UE. The transmission may pass via the base station, in accordance with the teachings of the embodiments described throughout this disclosure. In step 4730 (which may be optional), the UE receives the user data carried in the transmission.

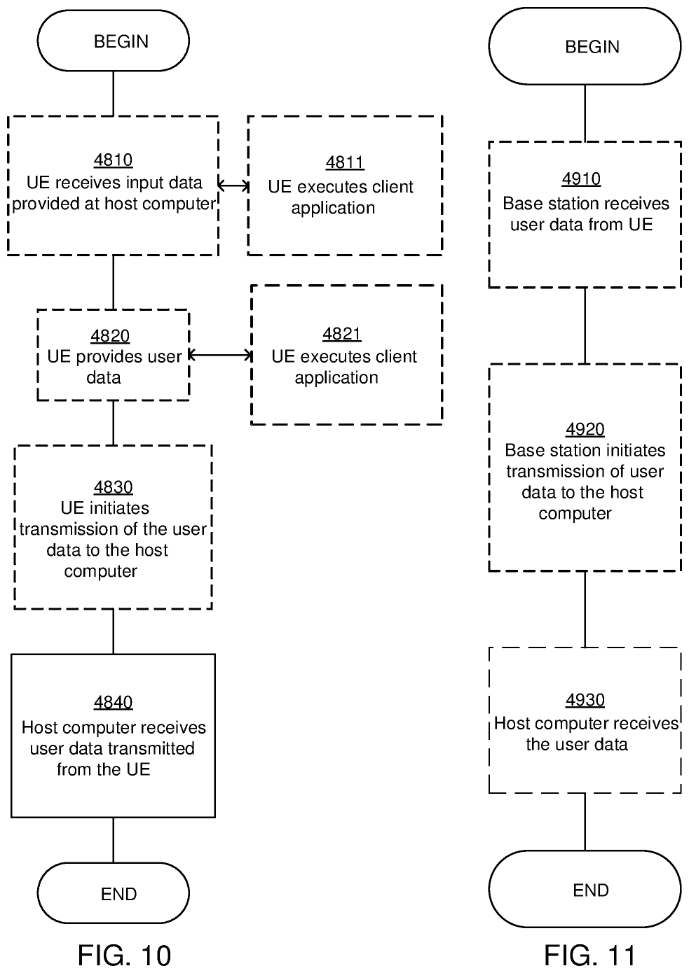

FIG. 10 is a block diagram of methods implemented in a communication system including a host computer, a base station, and a user equipment according to some embodiments. For simplicity of the present disclosure, only drawing references to FIG. 10 will be included in this section. In step 4810 (which may be optional), the UE receives input data provided by the host computer. Additionally or alternatively, in step 4820, the UE provides user data. In substep 4821 (which may be optional) of step 4820, the UE provides the user data by executing a client application. In substep 4811 (which may be optional) of step 4810, the UE executes a client application which provides the user data in reaction to the received input data provided by the host computer. In providing the user data, the executed client application may further consider user input received from the user. Regardless of the specific manner in which the user data was provided, the UE initiates, in substep 4830 (which may be optional), transmission of the user data to the host computer. In step 4840 of the method, the host computer receives the user data transmitted from the UE, in accordance with the teachings of the embodiments described throughout this disclosure.

FIG. 11 is a block diagram of methods implemented in a communication system including a host computer, a base station, and a user equipment according to some embodiments. FIG. 11 is a flowchart illustrating a method implemented in a communication system, in accordance with one embodiment. The communication system includes a host computer, a base station and a UE. For simplicity of the present disclosure, only drawing references to FIG. 11 will be included in this section. In step 4910 (which may be optional), in accordance with the teachings of the embodiments described throughout this disclosure, the base station receives user data from the UE. In step 4920 (which may be optional), the base station initiates transmission of the received user data to the host computer. In step 4930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

FIG. 12 illustrates an example computing environment 1200 implementing a method and the network node, as described in FIG. 3. As depicted in FIG. 12, the computing environment 1200 comprises at least one data processing module 1206 that is equipped with a control module 1202 and an Arithmetic Logic Unit (ALU) 1204, a plurality of networking devices 1208 and a plurality Input output, I/O devices 1210, a memory 1212, a storage 1214. The data processing module 1206 may be responsible for implementing the method described in FIG. 3. For example, the data processing module 1206 may in some embodiments be equivalent to the processor of the network node described above in conjunction with the FIG. 5. The data processing module 1206 is capable of executing software instructions stored in memory 1212. The data processing module 1206 receives commands from the control module 1202 in order to perform its processing. Further, any logical and arithmetic operations involved in the execution of the instructions are computed with the help of the ALU 1204.

The computer program is loadable into the data processing module 1206, which may, for example, be comprised in an electronic apparatus (such as a network node). When loaded into the data processing module 1206, the computer program may be stored in the memory 1212 associated with or comprised in the data processing module 1206. According to some embodiments, the computer program may, when loaded into and run by the data processing module 1206, cause execution of method steps according to, for example, any of the method illustrated in FIG. 3 or otherwise described herein.

The overall computing environment 1200 may be composed of multiple homogeneous and/or heterogeneous cores, multiple CPUs of different kinds, special media and other accelerators. Further, the plurality of data processing modules 1206 may be located on a single chip or over multiple chips.

The algorithm comprising of instructions and codes required for the implementation are stored in either the memory 1212 or the storage 1214 or both. At the time of execution, the instructions may be fetched from the corresponding memory 1212 and/or storage 1214, and executed by the data processing module 1206.

In case of any hardware implementations various networking devices 1208 or external I/O devices 1210 may be connected to the computing environment to support the implementation through the networking devices 1208 and the I/O devices 1210.

The embodiments disclosed herein can be implemented through at least one software program running on at least one hardware device and performing network management functions to control the elements. The elements shown in FIG. 12 include blocks which can be at least one of a hardware device, or a combination of hardware device and software module.

1. A method performed by a network node for transmission of data packets to a wireless device, the method comprising:
obtaining a packet delay budget, PDB, wherein the PDB represents a maximum allowable delay for a data packet;
determining a total delay time interval indicating a delay incurred for an estimated number of consecutive data packets transmitted from the network node to the wireless device; and
transmitting the data packets to the wireless device based on if the determined total delay time interval exceeds the obtained PDB or not.

2. The method according to claim 1, wherein the step of transmitting the data packets to the wireless device comprises:
selecting, when determined that the total delay time interval exceeds the PDB, at least one transmission parameter for transmitting the data packets to the wireless device;
adjusting a block error rate, BLER to a first BLER target of the data packets according to the selected at least one transmission parameter; and
transmitting the data packets to the wireless device with the first BLER target.

3. The method according to claim 2, wherein the transmission parameter comprises one or more of: a modulation and coding scheme, MCS, number of resource blocks, and a transmit power.

4. The method according to claim 1, wherein the total delay time interval comprises one or more of:
a scheduling delay indicating a difference between pre-determined time interval and actual time interval of transmission of each data packet to the wireless device;
a hybrid automatic repeat request, HARQ, round time trip, RTT, associated with retransmission of each data packet to the wireless device;
a delay associated with reception of acknowledgment and negative acknowledgement, A/N, from the wireless device; and
a decoding delay indicating time taken by the network node to decode reception of the A/N.

5. The method according to claim 1, wherein the step of transmitting the data packets to the wireless device comprises:
determining, when determined that the total delay time interval do not exceed the PDB, a reliability requirement indicating a survival time window for which a quality of service, QoS, has to be fulfilled for transmitting the data packets to the wireless device;
determining, according to the determined reliability requirement, a second BLER target of the data packets to be received by the wireless device within the survival time window; and
transmitting the data packets to the wireless device with the second BLER target of the data packets.

6. The method according to claim 5, wherein the step of determining the reliability requirement for transmitting the data packets to the wireless device comprises:
determining that a remaining PDB of at least one previously transmitted data packet is not within an allowed time interval for retransmission of the at least one previously transmitted data packet;
estimating a number of remaining transmissions of the data packets to be transmitted within the survival time window, when it has been determined that the remaining PDB of the at least one previously transmitted data packet is not within the allowed time interval for retransmission; and
determining the reliability requirement based on the estimated number of remaining transmissions.

7. The method according to claim 5, wherein the step of transmitting the data packets to the wireless device comprises:
selecting one or more of: a MCS, number of resource blocks, and a transmit power based on the reliability requirement for transmitting the data packets.

8. An apparatus of a network node configured to perform transmission of data packets to a wireless device, the apparatus comprising a controlling circuitry configured to cause:
obtaining of a packet delay budget, PDB, wherein the PDB represents a maximum allowable delay for a data packet;
determination of a total delay time interval indicating a delay incurred for an estimated number of consecutive data packets transmitted from the network node to the wireless device; and
transmission of the data packets to the wireless device based on if the determined total delay time interval exceeds the obtained PDB or not.

9. The apparatus according to claim 8, wherein the controlling circuitry is configured to cause transmission of the data packets to the wireless device by causing:
selection of at least one transmission parameter for transmitting the data packets to the wireless device, when determined that the total delay time interval exceeds the PDB;
adjusting of a block error rate, BLER to a first BLER target of the data packets according to the selection of the at least one transmission parameter; and
transmission of the data packets to the wireless device with the first BLER target.

10. The apparatus according to claim 9, wherein the transmission parameter comprises one or more of: a modulation and coding scheme, MCS, number of resource blocks, and a transmit power.

11. The apparatus according to claim 8, wherein the total delay time interval comprises one or more of:
a scheduling delay indicating a difference between pre-determined time interval and actual time interval of transmission of each data packet to the wireless device;
a hybrid automatic repeat request, HARQ, round time trip, RTT, associated with retransmission of each data packet to the wireless device;
a delay associated with reception of acknowledgment and negative acknowledgement, A/N, from the wireless device; and
a decoding delay indicating time taken by the network node to decode reception of the A/N.

12. The apparatus according to claim 8, wherein the controlling circuitry is configured to cause transmission of the data packets to the wireless device by causing:
determination of a reliability requirement indicating a survival time window for which a quality of service, QoS has to be fulfilled for transmitting the data packets to the wireless device, when determined that the total delay time interval do not exceed the PDB;
determination of a second BLER target of the data packets to be received by the wireless device within the survival time window, according to the determined reliability requirement; and
transmission of the data packets to the wireless device with the second BLER target of the data packets.

13. The apparatus according to claim 12, wherein the controlling circuitry is configured to cause determination of the reliability requirement for transmitting the data packets to the wireless device by:
determining that a remaining PDB of at least one previously transmitted data packet is not within an allowed time interval for retransmission of the at least one previously transmitted data packet;
estimating a number of remaining transmissions of the data packets to be transmitted within the survival time window, when it has been determined that the remaining PDB of the at least one previously transmitted data packet is not within the allowed time interval for retransmission; and
determining the reliability requirement based on the estimated number of remaining transmissions.

14. The apparatus according to claim 12, wherein the controlling circuitry is configured to cause transmission of the data packets to the wireless device by causing:
selection of one or more of: a MCS, number of resource blocks, and a transmit power based on the reliability requirement for transmitting the data packets.

15. A network node configured to perform transmission of data packets to a wireless device, the network node comprising controlling circuitry configured to cause the network node to:
obtaining of a packet delay budget, PDB, wherein the PDB represents a maximum allowable delay for a data packet;
determination of a total delay time interval indicating a delay incurred for an estimated number of consecutive data packets transmitted from the network node to the wireless device; and
transmission of the data packets to the wireless device based on if the determined total delay time interval exceeds the obtained PDB or not.

16. A non-transitory computer readable medium comprising instructions that when executed by a data processing unit perform the steps of:
obtaining a packet delay budget, PDB, wherein the PDB represents a maximum allowable delay for a data packet;
determining a total delay time interval indicating a delay incurred for an estimated number of consecutive data packets transmitted from the network node to the wireless device; and
transmitting the data packets to the wireless device based on if the determined total delay time interval exceeds the obtained PDB or not.
